(19) United States
(12) Patent Application Publication
(10) Pub. No.: US 2008/0107430 A1
(43) Pub. Date: May 8, 2008

(54) Mixed phase and wavelength coded optical code division multiple access system

(76) Inventor: Janet Lehr Jackel, Holmdel, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/262,663

(22) Filed: Oct. 31, 2005

Related U.S. Application Data
(63) Continuation-in-part of application No. 11/062,090, filed on Feb. 18, 2005.

(51) Int. Cl. H04B 10/04

(52) U.S. Cl. 398/188

(57) ABSTRACT

Apparatus and system for transmitting and receiving optical code division multiple access data over an optical network. The apparatus comprises a spectral phase decoder for decoding the encoded optical signal to produce a decoded signal, a time gate for temporally extracting a user signal from the decoded signal, and a demodulator that is operable to extract user data from the user signal. The system preferably comprises a source for generating a sequence of optical pulses, each optical pulse comprising a plurality of spectral lines uniformly spaced in frequency so as to define a frequency bin, a data modulator associated with a subscriber and operable to modulate the sequence of pulses using subscriber data to produce a modulated data signals and a Hadamard encoder associated with the data modulator and operable to spectrally encode the modulated data signal using only a subset of the frequency bins available in the system.

### CROSS-REFERENCE TO RELATED APPLICATIONS

This application is a continuation-in-part of U.S. application Ser. No. 11/062,090, filed on Feb. 18, 2005, the disclosure of which is hereby incorporated herein by reference.

### STATEMENT REGARDING FEDERALLY SPONSORED RESEARCH

Funding for research was partially provided by the Defense Advanced Research Projects Agency under federal contract MDA972-03-C-0078. The federal government has certain rights in this invention.

### BACKGROUND OF THE INVENTION

The present invention relates to optical communication and, more particularly, to optical code division multiple access (OCDMA) communication networks.

Various communications schemes have been used to increase data throughput and to decrease data error rates as well as to generally improve the performance of communications channels. As an example, frequency division multiple access (“FDMA”) employs multiple data streams that are assigned to specific channels disposed at different frequencies of the transmission band. Alternatively, time division multiple access (“TDMA”) uses multiple data streams that are assigned to different timeslots in a single frequency of the transmission band. FDMA and TDMA are quite limited in the number of users and/or the data rates that can be supported for a given transmission band.

In many communication architectures, code division multiple access (CDMA) has supplanted FDMA and TDMA. CDMA is a form of spread spectrum communications that enables multiple data streams or channels to share a single transmission band at the same time. The CDMA format is akin to a cocktail party in which multiple pairs of people are conversing with one another at the same time in the same room. Ordinarily, it is very difficult for one party in a conversation to hear the other party if many conversations occur simultaneously. For example, if one pair of speakers is excessively loud, their conversation will drown out the other conversations. Moreover, when different pairs of people are speaking in the same language, the dialogue from one conversation may bleed into other conversations of the same language, causing miscommunication. In general, the cumulative background noise from all the other conversations makes it harder for one party to hear the other party speaking. It is therefore desirable to find a way for everyone to communicate at the same time so that the conversation between each pair, i.e., their “signal”, is clear while the “noise” from the conversations between the other pairs is minimized.

The CDMA multiplexing approach is well known and is explained in detail, e.g., in the text “CDMA: Principles of Spread Spectrum Communication,” by Andrew Viterbi, published in 1995 by Addison-Wesley. Basically, in CDMA, the bandwidth of the data to be transmitted (user data) is much less than the bandwidth of the transmission band. Unique “pseudonoise” keys are assigned to each channel in a CDMA transmission band. The pseudonoise keys are selected to mimic Gaussian noise (e.g., “white noise”) and are also chosen to be maximal length sequences in order to reduce interference from other users/channels. One pseudonoise key is used to modulate the user data for a given channel. This modulation is equivalent to assigning a different language to each pair of speakers at a party.

During modulation, the user data is “spread” across the bandwidth of the CDMA band. That is, all of the channels are transmitted at the same time in the same frequency band. This is equivalent to all of the pairs of partygoers speaking at the same time. The introduction of noise and interference from other users during transmission is inevitable (collectively referred to as “noise”). Due to the nature of the pseudonoise key, the noise is greatly reduced during demodulation relative to the user's signal because when a receiver demodulates a selected channel, the data in that channel is “despread” while the noise is not “despread.” Thus, the data is returned to approximately the size of its original bandwidth, while the noise remains spread over the much larger transmission band. The power control for each user can also help to reduce noise from other users. Power control is equivalent to lowering the volume of a loud pair of partygoers.

CDMA has been used commercially in wireless telephone (“cellular”) and in other communications systems. Such cellular systems typically operate at between 800 MHz and 2 GHz, though the individual frequency bands may only be a few MHz wide. An attractive feature of cellular CDMA is the absence of any hard limit to the number of users in a given bandwidth, unlike FDMA and TDMA. The increased number of users in the transmission band merely increases the noise to contend with. However, as a practical matter, there is some threshold at which the “signal-to-noise” ratio becomes unacceptable. This signal-to-noise threshold places real constraints in commercial systems on the number of paying customers and/or data rates that can be supported.

Recently, CDMA has been used in optical communications networks. Such optical CDMA (OCDMA) networks generally employ the same general principles as cellular CDMA. However, unlike cellular CDMA, optical CDMA signals are delivered over an optical network. As an example, a plurality of subscriber stations may be interconnected by a central hub with each subscriber station being connected to the hub by a respective bidirectional optical fiber link. Each subscriber station has a transmitter capable of transmitting optical signals, and each station also has a receiver capable of receiving transmitted signals from all of the various transmitters in the network. The optical hub receives optical signals over optical fiber links from each of the transmitters and transmits optical signals over optical fiber links to all of the receivers. An optical pulse is transmitted to a selected one of a plurality of potential receiving stations by coding the pulse in a manner such that it is detectable by the selected receiving station but not by the other receiving stations. Such coding may be accomplished by dividing each pulse into a plurality of intervals known as “chips”. Each chip may have the logic value “1”, as indicated by relatively large radiation intensity, or may have the logic value “0”, as indicated by a relatively small radiation intensity. The chips comprising each pulse are coded with a particular pattern of logic “1”'s and logic “0”'s that is characteristic to the receiving station or stations that are intended to detect the transmission. Each receiving station is provided with optical receiving equipment capable of regenerating an optical pulse when it receives a pattern of chips coded in accordance with its own unique sequence but cannot regenerate the pulse if the pulse is coded with a different sequence or code.

Alternatively, the optical network utilizes CDMA that is based on optical frequency domain coding and decoding of ultra-short optical pulses. Each of the transmitters includes an optical source for generating the ultra-short optical pulses. The pulses comprise Fourier components whose phases are coherently related to one another. Each Fourier component is generally referred to as a frequency bin. A “signature” is impressed upon the optical pulses by independently phase shifting the individual Fourier components comprising a given pulse in accordance with a particular code whereby the Fourier components comprising the pulse are each phase shifted a different amount in accordance with the particular code. The encoded pulse is then broadcast to all of or a plurality of the receiving systems in the network. Each receiving system is identified by a unique signature template and detects only the pulses provided with a signature that matches the particular receiving system's template.

The individual components or apparatus that may comprise an OCDMA system are generally complex given the relatively high data rates and the processing of signals in the optical domain. For example, at the receiving end of a system transporting a 2.5 Gb/s data rate using an optical signal having 32 bins, processing of the optical signal requires detection of pulses having widths of only 12.5 pico-seconds (1/(2.5 Gb/s·32 bins)). This requires the use of relatively complex equipment (e.g., ultra-fast optical time gating) for a relatively low data rate signal of 2.5 Gb/s. Of utility then are methods and systems that reduce the complexity of the equipment utilized in OCDMA networks.

### SUMMARY OF THE INVENTION

An aspect of the present invention is an apparatus for generating an encoded optical signal. The apparatus preferably comprises a modulator operative to receive a train of optical pulses, each pulse in the train having N spectral lines and for modulating the train of optical pulses to produce a modulated signal and a spectral phase encoder operable to define a coding pattern having N symbols, each symbol being associated with a particular one of the N spectral lines. The N symbols are preferably partitioned into a plurality of distinct code sets, each distinct set having k symbols such that the ratio of k/N is less than 1 and one of the distinct sets is used to encode the modulated signal. Further, each code set may define a phase relationship.

Further in accordance with this aspect of the present invention, the optical pulses are generated by a mode locked laser.

Further in accordance with this aspect of the present invention, the ratio of k/N is preferably 1/2 or 1/4.

In addition, each symbol desirably shifts the phase of a predetermined spectral line by either 0 or π degrees.

It is also preferable that the N symbols comprise an orthogonal and binary code set and each distinct phase mask comprise an orthogonal and binary code subset within the orthogonal and binary code set. Further still, the orthogonal and binary code set comprise a binary Hadamard code. Additionally, each distinct phase mask comprise a binary Hadamard code.

In another aspect, the present invention is a multi-user optical code division multiple access system. The system preferably comprises a laser source for generating a train of optical pulses, each pulse having a plurality of sub-wavelengths, each sub-wavelength being associated with a frequency bin in the system; a plurality of data streams, each data stream being associated with one of a plurality of users; and a plurality of data modulators, each data modulator being associated with a distinct one of the plurality of digital data streams and being operative to modulate each optical pulse with the digital data stream to produce a plurality of modulated signals. In addition, the system further desirably comprises a plurality of spectral phase encoders, each encoder being associated with a data modulator and operative to encode a respective one of the modulated signals using a plurality of symbols comprising a Hadamard code, each symbol being operative to encode the phase of a distinct frequency bin. Each user is desirably assigned a phase based code defined by a subset of the symbols, each user phase based code encoding each modulated data stream such that each user is uniquely identified in the system.

Further in accordance with this aspect of the present invention, the system further comprises at least one decoder for receiving the encoded data stream and for decoding the encoded data stream using a conjugate of the phase code. In addition, the plurality of data modulators are operative to modulate the optical pulses.

Further in accordance with this aspect of the present invention, the plurality of data modulators are operative to modulate the optical pulses. The optical pulses may be amplitude or phase modulated. Further still, four or less of the symbols in a first user phase based code preferably overlap with the symbols in a second user phase based code.

Further still, the phase encoder preferably comprises a first grating coupled to a phase mask associated with each user and a second grating coupled to the same user's phase mask, the first grating being operable to spatially distribute the sub-wavelengths to predetermined sections of the user's phase code.

In another aspect, the present invention is a method comprising generating a sequence of optical pulses, each optical pulse comprising a plurality of spectral lines, the plurality of spectral lines defining a set of frequency bins in the optical network; modulating the sequence of optical pulses using data from N subscribers to produce a N modulated data signals; and encoding a subset of the frequency bins associated with each of the N modulated signals such that a unique code is associated with each of the N subscribers.

### BRIEF DESCRIPTION OF THE DRAWINGS

FIG. 1 illustratively depicts a system in accordance with an aspect of the present invention.

FIG. 2A illustratively depicts a source in accordance with an aspect of the present invention.

FIG. 2B is a spectral plot showing the modes or lines of a laser source in accordance with an aspect of the present invention.

FIG. 3 illustratively depicts an encoder/decoder in accordance with an aspect of the present invention.

FIGS. 4A and 4B illustratively depict an encoder/decoder in accordance with an aspect of the present invention.

FIG. 5 illustratively depicts a schematic of a spectral phase encoder in accordance with an aspect of the present invention.

FIG. 6 illustratively depicts a coding sequence and the resulting coded and decoded pulses.

FIG. 7 illustratively depicts a multi-user system in accordance with an aspect of the present invention.

### DETAILED DESCRIPTION

Additional details relating to the operation of the devices and systems described below are included in U.S. application Ser. No. 11/062,090, filed on Feb. 18, 2005, (“the '090 application”) the disclosure of which is hereby incorporated herein by reference.

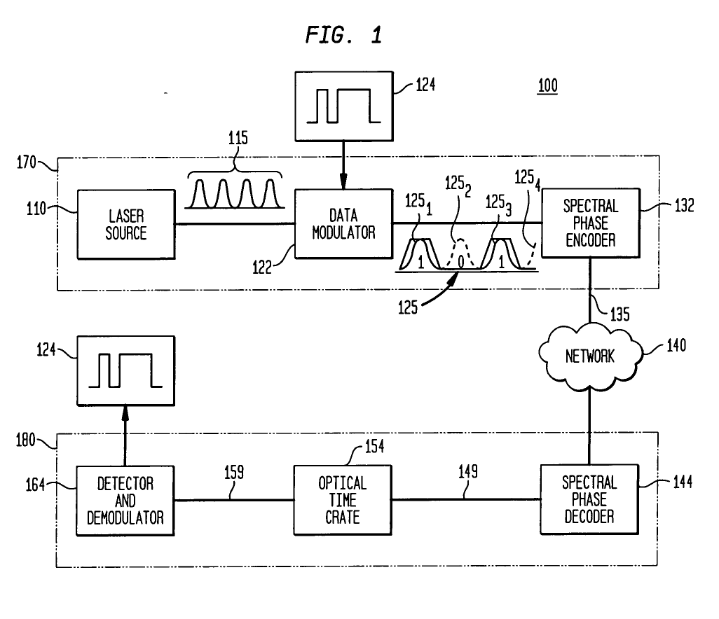

FIG. 1 illustratively depicts a system 100 in accordance with an aspect of the present invention. The system comprises a laser source 110 that generates a sequence of optical pulses 115 that are fed to a data modulator 120. The data modulator 122 also receives a data stream 122 that is used to modulate the sequence of optical pulses 115. The modulation data preferably comprises a digital data stream generated by a subscriber or user station 124. In a preferred embodiment, the data modulator 122 comprises an ON/OFF keyed data modulator wherein a “1” symbol or bit in the digital data stream corresponds to the presence of an optical pulse and a “0” symbol or bit corresponds to the absence of an optical pulse. In this way, each pulse represents a bit of information. For example, a modulated stream 125 is shown where the digital data stream comprises a “1010” data sequence. As shown, each time slot with the bit “1” will result in the presence of an optical pulse (125₁ and 125₃), whereas each time slot with a “0” bit indicates the absence of an optical pulse (125₂ and 125₄), which are shown as dashed lines to indicate their absence.

The modulated data stream 125 is then fed to a spectral phase encoder 132. As is discussed in further detail below, the spectral phase encoder 132 applies a phase code associated with a user to each optical pulse in the data stream to produce an encoded data stream 135. The phase code operates to provide a “lock” so that only a corresponding phase decoder with the appropriate “key” or phase conjugate of the phase code of the spectral phase encoder may unlock the encoded data stream. Typically, a spectral phase encoder is associated with a particular user and therefore allows only another user with the appropriate key to decode or receive information from the particular user. The information appears as noise to users that do not have the appropriate key.

The encoded data stream 135 may then be transported over a network 140, such as Wavelength Division Multiplex (WDM) network for example, to a spectral phase decoder 144 that, preferably, applies the phase conjugate of the phase code of the spectral phase encoder 132, as discussed above. The spectral phase decoder 144 provides a decoded data stream 149 to an optical time gate 150. As is discussed in detail below, the optical time gate 154 operates to reduce multiple access interference by temporally extracting only a desired user channel from among the decoded stream. The optical time gate 154 produces a user data stream 159, which is fed to a data demodulator 164. Where ON/OFF keying was employed at the transmitting end, the data demodulator 164 comprises an amplitude detector that reproduces the digital data stream 124.

In accordance with an aspect of the present invention, the laser source 110, data modulator 122 and spectral phase encoder 132 may comprise a transmitting station 170 associated with a user. The spectral phase decoder 144, optical time gate 154 and demodulator 164 may preferably comprise a receiving station 180 associated with a user.

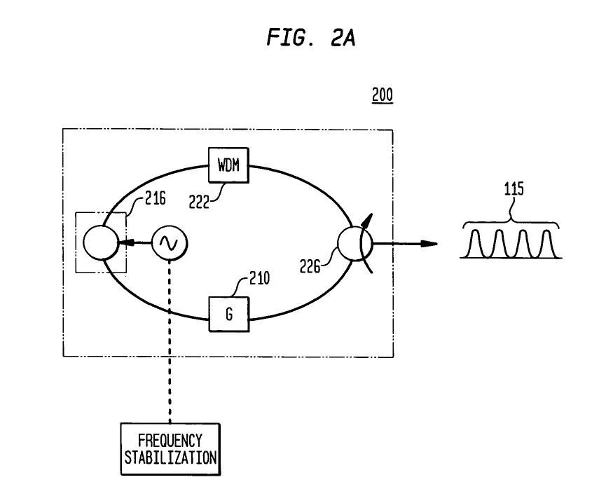

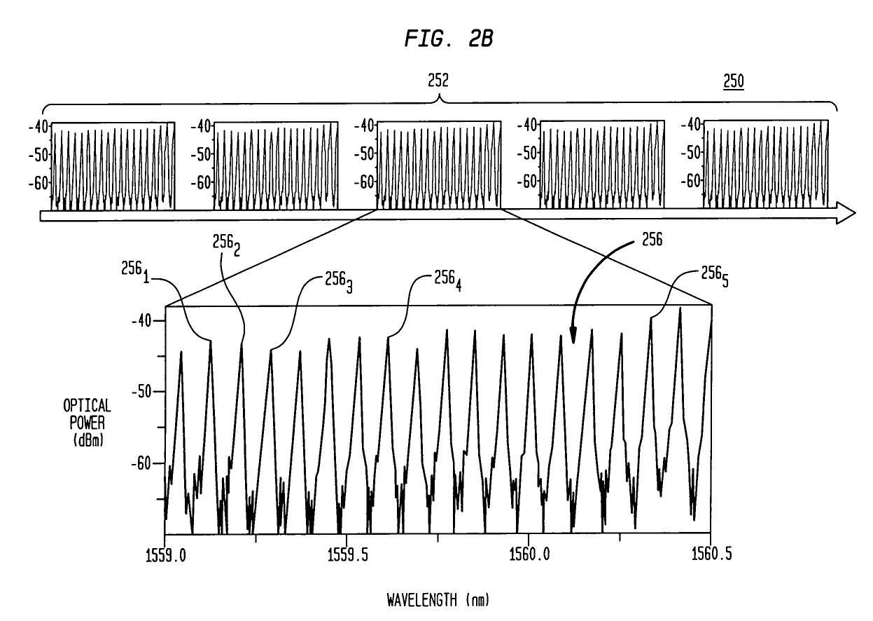

FIG. 2A illustratively depicts a laser source 200 that may be used to generate the pulse stream 115 in accordance with an aspect of the present invention. The laser source 200 preferably comprises a mode locked laser (MLL) having a spectral content comprising a stable comb of closely spaced phase-locked frequencies. The frequency or comb spacing is determined by the pulse repetition rate of the MLL. As shown in FIG. 2A, the source 200 may comprise a ring laser that may be formed using a semiconductor optical amplifier (SOA) or erbium doped fiber amplifier (EDFA). The ring laser illustrated in FIG. 2 includes a laser cavity 210, a modulator 216, a wavelength division multiplexer (WDM) 222 and a tap point 226 for providing an output signal, which comprises optical pulses 115.

FIG. 2B illustratively depicts a frequency plot 250 of the output of a MLL in accordance with an aspect of the present invention. The spacing of the longitudinal modes or lines is equal to the pulse repetition rate, for example, 5 GHz. As also seen in FIG. 2B, the total spectral width of the source may be limited to, for example, 80 GHz by placing an optical band pass filter in the laser cavity. The top portion 252 of FIG. 2B shows multiple windows that illustratively indicate the tunability of the source. Each line or mode 256 of the laser comprises a frequency chip or bin. FIG. 2B illustratively 16 frequency bins or chips in accordance with an aspect of the present invention.

In general, the electric field m(t) output of the MLL is a set of N equi-amplitude phase-locked laser lines:

$$m ( t ) = A {\sum }_{i = 1}^{N} {e}^{j ( 2 π {f}_{i} t + φ )} \qquad ( 1 )$$

where fᵢ=˜193 THz+(i−1)Δf are equally spaced frequencies. Signal m(t) is a periodic signal comprising a train of pulses spaced 1/Δf seconds apart and each pulse having a width equal to 1/(NΔf)seconds. We can also express (1) as:

$$m ( t ) = {\sum }_{k} p ( t - kT ) \qquad ( 2 )$$

where p(t)represents a pulse of duration T=1/Δf whose energy is mostly confined in the main lobe of width 1/(NΔf). With regard to FIG. 2A, N=16 and Δf is equal to 5 GHz.

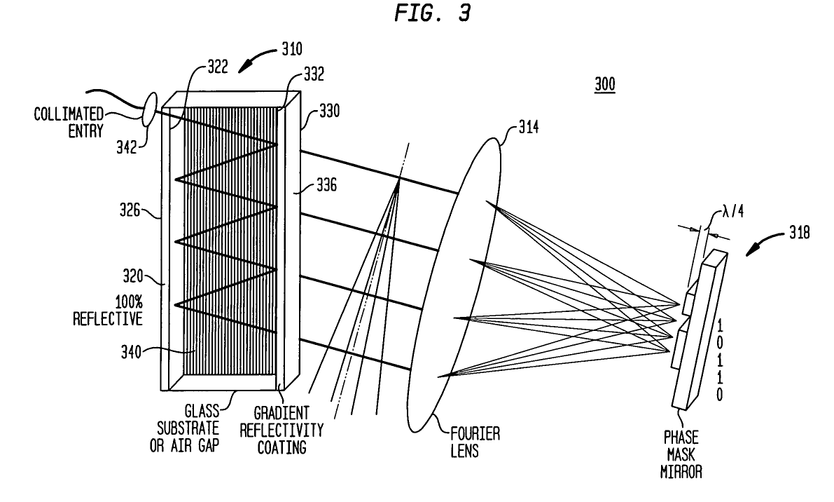

Turning now to FIG. 3, there is depicted a spectral phase encoder 300 in accordance with an aspect of the present invention. The encoder 300 includes a transparent plate 310, a Fourier lens 314 and a phase mask mirror 318. The plate 310 comprises a first element 320 that includes an inner surface 322 and an outer surface 326. The first element 320 is spaced from a second element 330 that also has an inner surface 332 and an outer surface 336. The inner surface 322 of the first element provided with a coating that is substantially 100% reflective. The inner surface 332 of the second element is provided a partially reflective coating. The first and second elements 320, 330 may be separated by a glass substrate 340, as shown, or by an air gap. The arrangement of the transparent plate and Fourier lens comprise an optical demultiplexer and may comprise structure or components as described in U.S. Pat. No. 6,608,721, the disclosure of which is incorporated herein by reference.

As shown, the first element 320 and glass substrate 340 are arranged such that an opening 342 is provided at one end of the plate 310. The opening 342 provides an entry point for a beam of light to enter the cavity so that a portion of the light beam is partially reflected by the surface 332 to surface 322, thereby establishing a cavity where the input light beam is split into multiple beams that are each projected onto the Fourier lens 314. The Fourier lens 314 then projects each mode or line of each beam to a particular location in space based on the wavelength or frequency of each mode. In particular, the phase mask mirror 318 is positioned at the focal plane of the Fourier lens 314 such that each mode or line is projected to a particular location on the phase mask mirror to cause a predetermined phase shift. In this way, the phase of each line or mode of the laser source (each such line or mode comprising a frequency bin or chip) is adjusted by a predetermined amount by the phase mask mirror. The phase mask mirror 318 then reflects the phase adjusted signals back through the Fourier lens 314 to the plate 310 where the phase adjusted signals exit through opening 342 as a collimated phase adjusted beam of light.

As shown in FIG. 3, each section of the phase mask 318 is recessed at 0 or λ/4 with respect to the focal plane of the Fourier lens 314 thereby representing a 0 or π phase shift, respectively. The phase mask of FIG. 3 includes five sections which comprise a “10110” phase mask, wherein a “1” represents a phase shift of π and a “0” represents a phase shift of 0. As is discussed in further detail below, each user is assigned a unique phase mask that includes a section for each frequency bin or chip in the system. The unique phase mask corresponds to a unique code or lock that is associated with a particular user such that a receiving unit needs the appropriate code or key to decipher a message from the particular user. In addition, the encoder 300 may also be used at the receive end as a decoder.

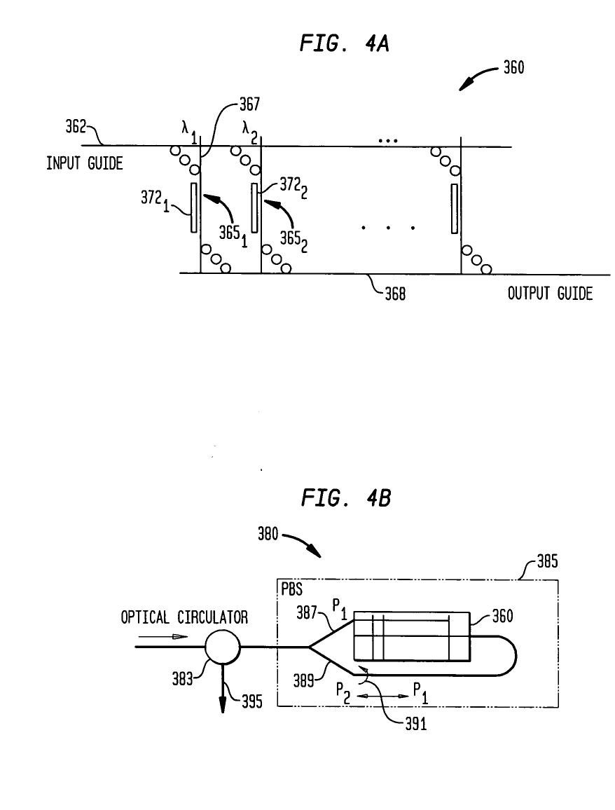

The encoder/decoder of FIG. 3 is typically large since it uses bulk optics. The size of such encoders/decoders typically make them susceptible to thermally induced drifts. Furthermore, the large size and complex alignment requirements may make it unlikely that the coder/decoder of FIG. 3 will be economically viable. As discussed above, spectral phase encoding consists of demultiplexing the various spectral components of a signal, shifting the phase of a portion of the spectrum based on the code and recombining the shifted components to produce the coded signal. The recombined signal no longer comprises a short optical pulse, but instead, the energy in the pulse is spread across the bit period in a pattern determined by the code. In accordance with an aspect of the present invention, we use a coder/encoder in form of an integrated photonic circuit, which uses ring resonators as wavelength selective subcomponents. FIG. 4A illustratively depicts a functional diagram of such a coder 360.

As shown in FIG. 4A, light enters from the left on the input guide 362. At a first ring resonator structure 365, subwavelength λ₁ is coupled off the guide 362 and onto the connecting guide (vertical line 367). At the bottom of vertical line 367, λ₁ is coupled onto the output guide 368 with another wavelength selective ring resonator. Each of the frequency components is coupled in the same way at the appropriate point. If all the connecting guides have the same optical length, and if the input and output guide have the same propagation constant, then all frequency components will see the same optical path length when they reach the end of the output guide. In this case, all would recombine with the same phase that they had at entry (i.e., this is equivalent to a code with all 0's or all 1's). To create a phase shift that defines a code, we use heaters on the connecting waveguides, shown here as blocks 372. The electrical connections to the heaters are not shown to avoid unnecessarily complicating the diagram. If the connecting waveguides are far enough apart, then they are sufficiently thermally isolated that the phase shifts can be applied independently. With thermal monitoring and feedback, independent phase shifts can be applied to each frequency even when the guides have some effect on each other.

A decoder typically has the same structure as an encoder, except that it may need to be polarization insensitive, since the signals may have their polarization altered in transmission through the fiber. The coder can have polarization dependence, since the initial mode-locked laser pulse is polarized.

An example of a polarization independent coder is shown in FIG. 4B. Note that each frequency passes through the same number of elements (two ring resonators for its frequency, and N−1 ring resonators that it passes through without being dropped/added) and the same optical path length, except for the phase shift that is applied thermally. Thus, each should experience the same loss. Consequently, there is no skewing of the amplitudes and the decoded pulse shape will be the same as the input to the coder. In addition, because the base path lengths are the same (except for some trimming to adjust for fabrication error) creating the correct phase relationships will typically be straightforward.

For polarization insensitivity we use the same structure at the core, but separate input polarizations, and have them pass through the coder/decoder 380 as shown in FIG. 4B.

As shown in FIG. 4B, light enters and passes through an optical circulator 383. The light is split into two polarizations using a polarization beamsplitter (PBS) 385 and one polarization follows the upper path 387 while the orthogonal polarization follows the lower path 389. On the lower path a polarization rotator 391 converts the polarizations from one mode to another orthogonal mode, e.g., P₁ into P₂ (or vice versa). The light in the upper path enters the coder structure 393 in polarization mode 1 at the point previously called the input 362, and the light in the lower path enters the coder also in polarization mode 1, but at the point previously called the output 368, traveling in the opposite direction. The light from the upper path exits the coder, passes through the polarization rotator and is converted to polarization mode 2, which then passes through the PBS 385 and is sent back to the circulator 383 from which it exits along the path shown as a vertical line 395. The light from the lower path, now in polarization mode 1, goes through the coder in the opposite direction, but experiences precisely the same phase shifts and optical path lengths as the light from the upper path. It exits the coder and is recombined in the PBS 385, and exits the circulator 383 in the same way as the light from the other path. Thus, this comprises a polarization independent component. The structures that are shown in block 385 can either be realized in fiber or can be built onto an optical waveguide. Without this polarization independent construction, it would be necessary to have a polarization sensor and a dynamic polarization rotator before the decoder. Note that in this design, path lengths are the same and the path is the same for both polarizations. The difference is that the two polarizations traverse the path in opposite directions.

Returning to FIG. 1, the encoded signal 135 is then transmitted over a network 140 to a decoder 144. In a preferred embodiment, the network 140 comprises a WDM network. In such an implementation, the OCDMA network comprises an overlay architecture that is compatible with existing WDM network technologies as is discussed in further detail below.

As discussed above, the encoded signal 135 is decoded by a spectral phase decoder 144. The spectral phase decoder 144 will typically comprise the arrangement shown in FIGS. 3 and 4, except that, in general, the decoder will apply the phase conjugate of the phase mask applied by the encoder. Note, however, that where the phase mask uses a binary coding scheme, the code is its own complement and consequently the coder and decoder are identical.

The signal 149 from the spectral phase decoder 144 is then fed to the optical time gate 154. Additional details regarding the construction and operation of different types of optical time gates that may be employed are disclosed in the '090 application.

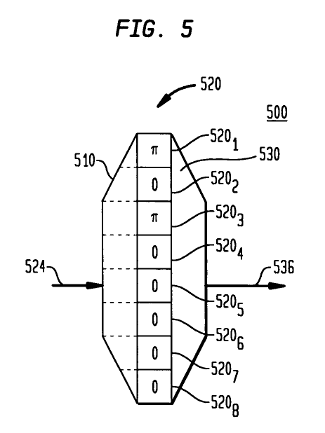

Turning now to FIG. 5, there is shown a schematic of a spectral phase encoder 500 in accordance with an aspect of the present invention. The spectral phase encoder 500 comprises a first grating 510, a phase mask 520 and a second grating 530. The phase mask is illustrated as having eight sections, one for each wavelength, mode or frequency bin comprising a beam of light 524. The beam of light 524 enters the first grating 510 and is spatially distributed based on the different wavelengths or frequency bins that comprise the light beam 524. This spatial distribution preferably results in each mode being limited to a predetermined section (520₁, through 520₈) of the phase mask 520. The phase mask 520 spectrally encodes the beam 524 and passes the encoded signal to the grating 530. The second grating 530 then spatially recombines the bins into an encoded beam 536.

In lieu of spectrally encoding each frequency bin, the phase mask 520 encodes only a subset of the frequency bins. The phase mask shown includes 8 sections, 520₁-520₈, that are used to define a coding pattern or phase code. As shown for example, the phase code may be defined using only the first four sections (e.g., 520₁ to 520₄) of the mask. These four sections may comprise a “1010” phase code or pattern, where a “1” represents a π phase shift and a “0” represent a phase shift of “0.” The remaining sections (520₅ to 520₈) would not be used in spectrally encoding the signals and would be set to a “0” phase shift. Encoding the beam 524 using only a contiguous subset of the sections comprising the phase mask results in the decoded bit at the receiver having a longer pulse width or bit period. For the example given in FIG. 5, the pulse width is approximately two times wider than when all 8 frequency bins are spectrally encoded.

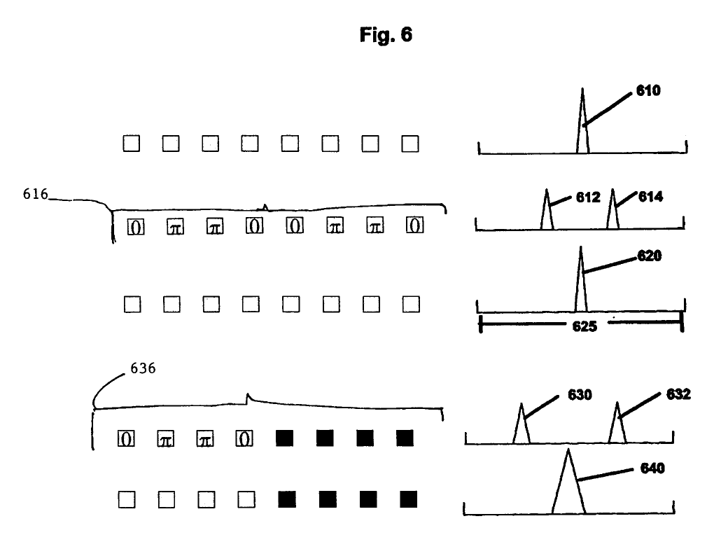

In particular, FIG. 6 shows an example of how the pulse width of a signal may vary based on how coding is done. The pulse 610 shows a bit before encoding. The pulses 612 and 614 show the bit after spectral encoding using all eight sections of a phase mask 616 with the pattern “01100110”. The decoded bit is shown as pulse 620 and is identical to the un-encoded pulse 610 and is approximately ⅛ the length of the bit period 625. Pulses 630, 632 show a bit that is encoded using only four sections of a phase mask 636 with the pattern “0110 - - - ”. The dashes indicate an amplitude of zero. The zero amplitude can be implemented in a phase mask (mirror) by removing or blocking the mirror. In an implementation that uses ring resonators, a smaller number of ring resonators are used and only a subset of the frequencies is selected. There are at least two advantages to this method: First, if contiguous frequencies are used, there is a smaller total optical spectral span, and the output pulse after decoding is wider, reducing the demand on the time gate. When non-contiguous frequencies are chosen, the spectral span will be larger, possibly as wide as the entire original set of frequencies, for certain choices of frequency subsets, and the pulse may be quite short. But the number of potentially interfering codes is reduced as noted.

Pulse 640 shows the decoded bit, which has a pulse width that is twice as wide as pulse 620. The wider pulse 640 may be more easily detected by an optical time gate at the receiving end. This advantageously allows for less complex design of the optical time gating circuitry. Furthermore, there will be only half as many interfering signals, easing the task of separating the desired data from interfering data.

In addition, the unused frequencies may be used to encode another user's data since that code would be distinguishable from coding done using the first four sections.

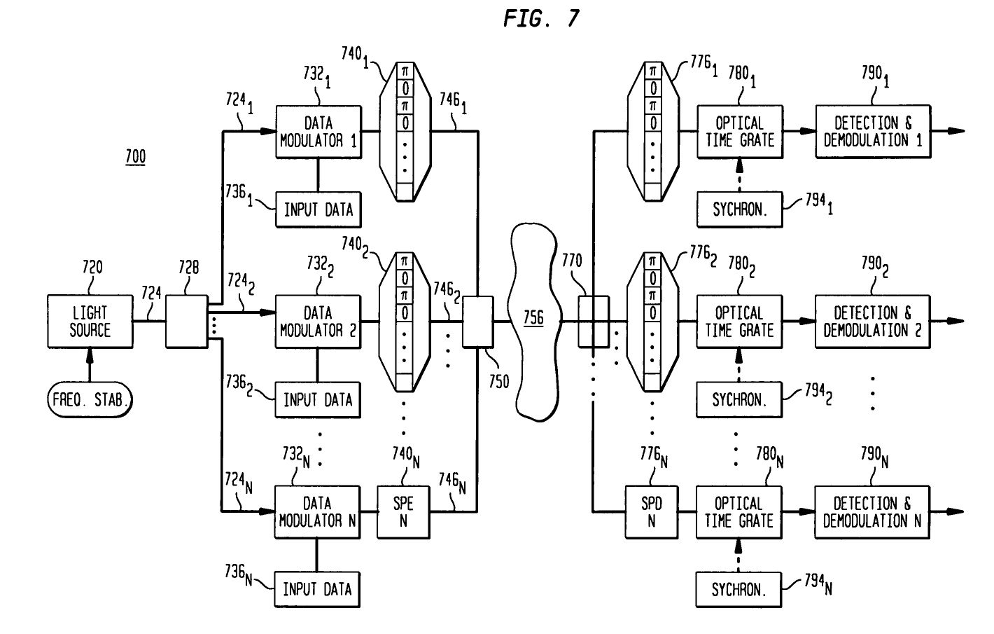

Turning now to FIG. 7, there is shown a multi-user OCDMA system 700 in accordance with an aspect of the present invention. As shown, the system includes a light source 720 that generates a train or sequence of light pulses 724. In the preferred embodiment, the light source 720 comprises a multi-wavelength laser in which each sub-wavelength or line that make up the laser's spectrum comprises a frequency bin in the system 700. In that regard, for a system having 16 bins, the spectral content of the light source 720 may be as shown in FIG. 2B. The number of bins may be chosen based on the level of security desired and the number of users. The light pulses 724 are split or divided at block 728, which may comprise a power divider, for distribution to a plurality of data modulators 732.

Each of the data modulators 730 receive input data from data source 736. Each data source 736 is associated with a user or subscriber. As shown, the system includes N subscribers. The data modulators 730 may modulate the light pulses 724 by the respective input data using amplitude modulation or any other available scheme. In the preferred embodiment, the data modulators 532 operate to provide ON/OFF keying resulting in a time-domain signal in which a “1” symbol or bit appears as a pulse and a “0” symbol or bit does not appear as a pulse, as previously discussed.

Each of the modulated optical pulse signals are then fed to respective spectral phase encoders 740₁ through 740_{N} as shown. Encoding consists of separating a subset of the frequency bins (e.g., 520₁, 520₂, etc.), shifting its phase, in this case by 0 or π, as prescribed by the choice of code, and recombining the frequency bins to produce a coded signal 746. When the relative phases of the frequencies are shifted, the set of frequencies is unaltered, but their recombination results in a different temporal pattern, e.g., a pulse shifted to a different part of the bit period, multiple pulses within the bit period, or noise-like distribution of optical power. Each OCDMA code is desirably defined by a unique choice of phase shifts. Preferably, a set of codes is chosen that makes efficient use of the spectrum within the window, and that can also be separated from each other with acceptable error rates, even when a maximum number of codes occupy the window.

For the system 700 we chose the set of Hadamard codes, which are orthogonal and binary. This choice is desirable it that is can achieve relatively high spectral efficiency with minimal multi-user interference (MUI). This coding schemes offers orthogonally in the sense that MUI is zero at the time that the decoded signal is maximum. The number of orthogonal codes is equal to the number of frequency bins; hence, relatively high spectral efficiency is possible. Binary Hadamard codes are converted to phase codes by assigning to +1's and −1's phase shifts of 0 and π, respectively. To encode data, which contains a spread of frequencies, as opposed to the unmodulated pulse stream, which contains only the initial comb of frequencies produced by the MLL, it is preferable to define frequency bins around the center frequencies. Encoding data then consists of applying the phase shift associated with a frequency to the entire bin. The output of the phase encoder is then a signal obtained by summing the phase-shifted frequency components of the modulated signal, or equivalently, by convolving the modulated optical signal at the input of the phase encoder with the inverse Fourier transform of the phase code.

Applying any of these orthogonal codes (except for the case of Code 1, which leaves all phases unchanged) results in a temporal pattern which has zero optical power at the instant in time where the initial pulse would have had its maximum power. Although this choice of orthogonal codes implies synchronicity as a system requirement, since desynchronization will move unwanted optical power into the desired signal's time slot, careful code selection allows some relaxation of this requirement. For example, simulations indicate that for four simultaneous users transmitting at 2.5 Gb/s and using a suitably chosen set of four codes among the set 16 Hadamard codes of length 16, up to 15 ps of relative delay can be tolerated with a power penalty within 1 dB at a BER of 10⁻⁹.

Any of the coders shown in FIGS. 3 and 4 may be used to implement the coding scheme. Note, however, that other coders may be used such as on-chip and arrayed waveguide gratings. For example, wavelengths can be separated using an on-chip grating (as opposed to a free-space component for spreading the spectrum), and then reflected back with appropriate phase shifts. Such gratings have been made in semiconductor materials and may be user to tune the phase shifts so as to create a dynamic coder. Wavelengths can also be separated using an arrayed waveguide grating (AWG), phase shifted on the same substrate, and then recombined in the same AWG (reflective geometry) or in a separate one.

In accordance with this aspect of the present invention, only a subset of the available frequency bins or phase mask sections are coded. For example, in a system that includes 32 frequency bins, the phase mask may be divided into four subsets, e.g., A, B, C and D. Each subset may comprise a different coding pattern. In addition, the coding patterns between subsets may overlap to some degree. Where it is desired to have the coded bits appear to look more like noise (as opposed to the sharp pulses shown in FIG. 6), then a non-orthogonal code may be used to scramble the coded signal. For example, the first set of codes A, B, C, D, etc. may be chosen so as to be orthogonal. A common code E, which is not part of the orthogonal set to which A, B, C, D belong, may then be applied to each of the codes A . . . D, or the combination of these codes to scramble the coded signals. In general, If one of the original codes, or any other code in the same Hadamard set, is used as the common scrambling code, each of the original codes will be transformed into a different member of the same Hadamard set. Hence the scrambling will not make the combined codes look more “noise-like.”

The encoded user signals 746 are combined at block 750 prior to transmission over the network 756. The network 756 preferably comprises a Wavelength Division Multiplex (WDM) network that allows the signals of the system 700 to be transported transparently to the other signals that are normally carried by the WDM network. In that regard, the system 700 advantageously uses a relatively small and tunable window, which is compatible with WDM systems that are currently deployed.

After the encoded signals traverse the network 756, they are split 770 and provided to a plurality of matching decoders 776. In particular, decoding may be accomplished by using a matched, complementary code; for the binary codes used here, the code is its own complement and consequently the coder and decoder are identical. The decoded signal has the pulses restored to their original position within the bit period and restores the original pulse shape. Decoding using an incorrect decoder results in a temporal pattern that has zero optical power at the center of the bit period and the majority of the energy for that pulse is pushed outside the time interval where the desired pulse lies.

The signal from the phase decoder 776 is then further processed by an optical time gate 780 and data demodulator 790 to reproduce the user or subscriber data signal. As also seen in FIG. 7, a synchronization block 794 is coupled to each of the optical time gates 580. The synchronization block 794 supplies a control or clock signal that closes the time gate at the proper time interval. As previously discussed, by using only a section or portion of the available frequency bins for coding, the timing requirements at the optical time gate is relaxed. In particular, the wider pulse widths relax the time period during which the optical time gate needs to be closed. This in turn relaxes the requirements on the switching times associated with the synchronizing equipment. This advantageously allows less sophisticated equipment to be used in these types of systems.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An apparatus for generating an encoded optical signal, comprising:
a modulator operative to receive a train of optical pulses, each pulse in the train having N spectral lines and for modulating the train of optical pulses to produce a modulated signal; and
a spectral phase encoder operable to define a coding pattern having N symbols, each symbol being associated with a particular one of the N spectral lines, and
wherein the N symbols are partitioned into a plurality of distinct code sets that each define a phase relationship, each distinct set having k symbols such that the ratio of k/N is less than 1 and one of the distinct sets is used to encode the modulated signal.

2. The apparatus of claim 1, wherein the optical pulses are generated by a mode locked laser.

3. The apparatus of claim 1, wherein the ratio of k/N is 1/2.

4. The apparatus of claim 1, wherein the ratio of k/N is 1/4.

5. The apparatus of claim 1, wherein each symbol is used to shift the phase of a predetermined spectral line by a fixed amount of either 0 or π degrees.

6. The apparatus of claim 1, wherein the N symbols comprise an orthogonal and binary code set and each distinct phase mask comprise an orthogonal and binary code subset within the orthogonal and binary code set.

7. The apparatus of claim 6, wherein the orthogonal and binary code set comprise a binary Hadamard code.

8. The apparatus of claim 6, wherein each distinct phase mask comprise a binary Hadamard code.

9. A multi-user optical code division multiple access system, the system comprising:
a laser source for generating a train of optical pulses, each pulse having a plurality of sub-wavelengths, each sub-wavelength being associated with a frequency bin in the system;
a plurality of data streams, each data stream being associated with one of a plurality of users;
a plurality of data modulators, each data modulator being associated with a distinct one of the plurality of digital data streams and being operative to modulate each optical pulse with the digital data stream to produce a plurality of modulated signals; and
a plurality of spectral phase encoders, each encoder being associated with a data modulator and operative to encode a respective one of the modulated signals using a plurality of symbols comprising a Hadamard code, each symbol being operative to encode the phase of a distinct frequency bin, and
wherein each user is assigned a phase based code defined by a subset of the symbols, each user phase based code being operable to encode each modulated data stream such that each user is uniquely identified in the system.

10. The system of claim 9, further comprising at least one decoder for receiving the encoded data stream and for decoding the encoded data stream using a conjugate of the phase based code.

11. The system of claim 9, wherein the plurality of data modulators are operative to modulate the amplitude of the optical pulses.

12. The system of claim 9, wherein four or fewer of the symbols in a first user's phase code overlap with the symbols in a second user phase code.

13. The system of claim 9, wherein the phase encoder comprises a first grating coupled to a phase mask associated with each user and a second grating coupled to the same user's phase mask, the first grating being operable to spatially distribute the sub-wavelengths to predetermined sections of the user's phase based code.

14. The system of claim 9, wherein each frequency bin is shifted by 0 or π by each symbol comprising a phase mask.

15. A method for preparing data for transport over an optical network, comprising:
generating a sequence of optical pulses, each optical pulse comprising a plurality of spectral lines, the plurality of spectral lines defining a set of frequency bins in the optical network;
modulating the sequence of optical pulses using data from N subscribers to produce a N modulated data signals; and
encoding a subset of the frequency bins associated with each of the N modulated signals such that a unique code is associated with each of the N subscribers.

16. The system of claim 15, wherein encoding comprises encoding a subset of the frequency bins associated with each of the N modulated signals with a binary and orthogonal binary code such that a unique code is associated with each of the N subscribers.

17. The system of claim 16, wherein the orthogonal and binary code is chosen from the set of Hadamard codes.
